(19) United States
(12) Patent Application Publication
(10) Pub. No.: US 2025/0315538 A1
(43) Pub. Date: Oct. 9, 2025

(54) Key Store System For Controlling Access To Keys

(71) Applicant: Altera Corporation, San Jose, CA (US)

(72) Inventors: Aditya Katragada, Austin, TX (US); Andrew Draper, Chesham (GB)

(73) Assignee: Altera Corporation, San Jose, CA (US)

(21) Appl. No.: 19/245,108

(22) Filed: Jun. 20, 2025

(51) Int. Cl. G06F 21/60; H04L 9/08

(52) U.S. Cl. CPC G06F 21/604; G06F 21/602; H04L 9/0894

(57) ABSTRACT

A computing system or an integrated circuit includes a key storage circuit for storing a key and an access control enforcer circuit that grants access to the key stored in the key storage circuit in response to receiving a request based on a hardware identifier that identifies a hardware system and a subcomponent of the hardware system that is an owner of the key. The access control enforcer circuit accesses a hardware property for a key from an access control attributes circuit in response to a request to access the key. The access control enforcer circuit prevents the key from being returned to an initiator of the request if the hardware property indicates that the key is protected. The access control enforcer circuit permits the key to be used to derive, wrap, or unwrap other keys if the hardware property indicates that the key is protected.

### BACKGROUND

Configurable integrated circuits can be configured by users to implement desired custom logic functions. In a typical scenario, a logic designer uses computer-aided design (CAD) tools to design a custom circuit design. When the design process is complete, the computer-aided design tools generate configuration data containing configuration bits. The configuration data is then loaded into configuration memory elements that configure configurable logic circuits in the integrated circuit to perform the functions of the custom circuit design. Configurable integrated circuits can be used for co-processing in big-data or fast-data applications. For example, configurable integrated circuits can be used in application acceleration tasks in a datacenter and can be reprogrammed during datacenter operation to perform different tasks.

### BRIEF DESCRIPTION OF DRAWINGS

FIG. 1 is a diagram that illustrates an example of a computing system that is managed by a key store system.

FIG. 2 is a diagram that illustrates detailed examples of agents of FIG. 1 that can implement techniques for key access control disclosed herein.

FIG. 3 is a diagram that illustrates an example of an implementation of a key derivation function in the hardware sequencer circuit of FIG. 1.

FIG. 4 is a diagram of an illustrative example of a configurable integrated circuit (IC).

FIG. 5 illustrates a block diagram of a system that can be used to implement a circuit design to be programmed into a programmable logic device using design software.

FIG. 6 is a diagram that depicts an example of a programmable logic device that includes fabric dies and base dies that are connected to one another via microbumps.

FIG. 7 is a block diagram illustrating a computing system configured to implement one or more aspects of the embodiments described herein.

### DETAILED DESCRIPTION

Most security controllers in integrated circuits (ICs) implement key stores to protect critical system level use case keys. These keys are generally accessible to trusted software and firmware components (e.g., Read Only Memory (ROM) code), but are not accessible to non-trusted firmware components that are not within the trust network for particular keys. A variant of the firmware that is not in the trust network for certain keys is firmware that has been compromised by means of a hack (e.g., due to bugs or targeted hacks). Generally, security architects build defense in depth within hardware and firmware to prevent direct access of the keys to firmware after the keys have been stored. Keys are sometimes indirectly exposed using an identifier that can be used to reference the actual keys. The expectation is that trusted firmware will use a key directly or indirectly through the identifier (where multiple roles of firmware exist) to access the key indirectly, and the key confidentiality is met.

One problem with the indirect usage technique described above is that if firmware gets compromised due to a vulnerability, the identifier is still usable, thereby making the identifier as valuable as the key itself. If an attacker can make the firmware use the key through cryptographic engines, the attacker can make the firmware leak the key value. As an example, some cryptographic algorithms in some modes with known data can be used to infer key values. Another problem with hardware key protection is that when firmware is implemented in different stages, then all of the stages get access to the keys using the key identifier, thereby forcing them all to be within the trust network of the key usage.

An example of a flow where this technique causes a problem is Device Identifier Composite Engine (DICE) based key derivation using the UDS (unique device secret) adhering to the Trusted Computing Group (TCG) DICE specification. The UDS is expected to be protected and prevented from being used once the CDI (component device identifier) is generated by the Root of Trust Read Only Memory (ROM) firmware. The CDI is derived by the ROM when the CDI is loading runtime firmware having measurements that are incorporated into the CDI derivation. Runtime firmware generally should not get access to the UDS. If the runtime firmware is compromised, the compromised firmware should not be able to jump back to sections of ROM code (e.g., gadgets in ROM code) or re-derive the CDI using a different firmware breaking all subsequent attestation flows.

As described above, most existing solutions deploy a mode in which the key storage hardware does not expose the key to software or firmware once initialized and only exposes the key to the hardware cryptographic engines that need to use the keys within the hardware itself. This solution has a disadvantage that while untrusted firmware cannot get access to the clear key value, the untrusted firmware can use the key through the cryptographic hardware, and thereby either misuse the key or indirectly decode the key using cryptoanalysis.

Some security code makes use of lock bits set by firmware to prevent key usage after the intended valid usage of the key. This solution is not very effective when a key is expected to be used multiple times, because the property of key protection extends to the lock bit, which in this case requires unlocking when the right firmware or agent intends to use the key. As an example, keys derived from a Security Protocol and Data Model (SPDM) session key are expected to derive link encryption keys. The SPDM session key is a high value key and can be used multiple times, but cannot be locked out permanently. If there is a way to unlock the key's usage, the unlocking should not be allowed to unauthorized firmware.

According to some examples disclosed herein, three techniques are provided for preventing unauthorized or compromised firmware or any other agent from accessing or using keys stored in a secure key storage device. When used separately or together, these three techniques can be used to build robust and secure key protection systems. According to the first technique, a key store system controls key storage and access based on hardware identifiers. The hardware identifiers uniquely identify owners of the keys. Access to a key is granted only when a hardware identifier associated with a request to access the key matches the hardware identifier for that key that is stored in the key store system. For example, a hardware identifier can identify a central processing unit (CPU) in a multi-core system. As another example, a hardware identifier can identify a mode running on a CPU. As yet another example, a hardware identifier can identify a process or application running on a CPU. As still another example, a hardware identifier can identify any controller using a cryptographic subsystem.

According to the second technique, a hardware protected mode property is associated with high value keys that are used in key derivation of other keys. This hardware protected mode property is a hardware enforced attribute (e.g., high security or low security) that is used in key derivation that defines the security of the derived keys. This second technique includes a hardware sequencer that ensures that certain keys derived with high security attributes are highly secure and are never exposed to firmware directly or indirectly or software outside of the key store system. The keys can only be used by hardware to route to other cryptographic engines, etc. Keys that are derived with the low security attribute can be returned to firmware and software for other usages. This second technique prevents unauthorized firmware from ever deriving keys with high security properties and getting access to these high security keys.

According to the third technique, a hardware protected mode property is associated with high value keys that only allows the high value keys to be used for key wrap functions (i.e., key wrapping) and key unwrap functions (i.e., key unwrapping) by a hardware sequencer. The high value keys that are used to perform the wrap functions are never exposed to software or firmware. Keys that are unwrapped using the high value keys can be routed to hardware and prevented from firmware access if the system supports this hardware protected mode property. Key wrapping is a process of protecting a key by encrypting the key with another key. Key unwrapping is the process of extracting the originally wrapped key.

One or more specific examples are described below. In an effort to provide a concise description of these examples, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Throughout the specification, and in the claims, the terms “connected” and “connection” mean a direct electrical connection between the circuits that are connected, without any intermediary devices. The terms “coupled” and “coupling” mean either a direct electrical connection between circuits or an indirect electrical connection through one or more passive or active intermediary devices that allows the transfer of information between circuits. The term “circuit” may mean one or more passive and/or active electrical components that are arranged to cooperate with one another to provide a desired function.

This disclosure discusses integrated circuit devices, including configurable (programmable) integrated circuits, such as field programmable gate arrays (FPGAs) and programmable logic devices (PLDs). As discussed herein, an integrated circuit (IC) can include hard logic and/or soft logic. The circuits in an integrated circuit device (e.g., in a configurable IC) that are configurable by an end user are referred to as “soft logic.” “Hard logic” generally refers to circuits in an integrated circuit device that have substantially less configurable features than soft logic or no configurable features.

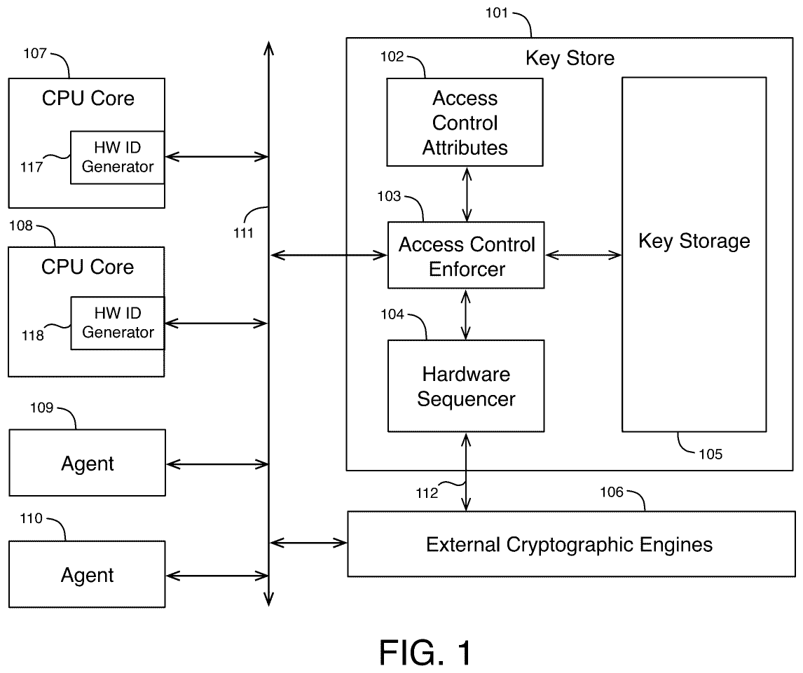

FIG. 1 is a diagram that illustrates an example of a computing system that is managed by a key store system 101. Key store system 101 includes an access control attributes circuit 102, an access control enforcer circuit 103, a hardware sequencer circuit 104, and a key storage circuit 105. Key store system 101 is in communication with external cryptographic engines 106 through bus 112. Key store system 101 is also in communication with central processing unit (CPU) core circuit 107, CPU core circuit 108, agent 109, and agent 110 through bus 111 (e.g., an Advanced Extensible Interface (AXI) bus). Each of the CPU core circuits 107-108 can be virtualized and run different environments. The key store system 101 can be formed in any types of one or more integrated circuits (ICs). Each of these one or more ICs can be, as examples, a configurable IC (e.g., a field programmable gate array (FPGA) or programmable logic device (PLD)), a microprocessor IC, a graphics processing unit IC, a memory IC, an application specific IC, a transceiver IC, a memory IC, etc.

The access control enforcer circuit 103 in key store system 101 can generate keys and can store the keys in key storage circuit 105. Hardware (HW) identifier (ID) generator 117 in CPU core circuit 107 and hardware (HW) identifier (ID) generator 118 in CPU core circuit 108 can generate hardware identifiers for the keys. Each of the hardware identifiers identifies a hardware system and a subcomponent of the hardware system that is an owner of the key and has access to the key. As examples, each of the hardware identifiers can identify a hardware system (e.g., one of CPU cores 107-108) and a subcomponent of the hardware system (e.g., hardware, firmware, or software in CPU core 107 or 108) that owns the key. The hardware identifiers are provided to access control enforcer circuit 103 through bus 111 for storage in access control attributes circuit 102.

The keys may be, as examples, encryption keys or other types of security keys. Any number of keys and keys having any length can be stored in the key storage circuit 105, depending on the storage capacity of the key storage circuit 105. The storage capacity of the key storage circuit 105 determines the number of keys and the length of keys that can be stored in key storage circuit 105.

The access control attributes circuit 102 includes a table that maps each key stored in the key storage circuit 105 to a hardware identifier that identifies an owner that owns and has access to the key. The access control attributes circuit 102 can also store hardware properties for the keys that identify the keys as protected or unprotected. The access control attributes circuit 102 can exchange the hardware identifiers and the hardware properties with the access control enforcer circuit 103.

The hardware identifiers that are stored in the access control attributes circuit 102 for the keys can be initialized by the agents that created the keys or can be defined in hardware register transfer level code (HW RTL) statically per key slot. As examples, HW ID generator 117 in CPU core circuit 107 and HW ID generator 118 in CPU core circuit 108 can generate hardware identifiers and hardware properties for various keys. The HW generators 117-118 can provide the hardware identifiers for the keys and the hardware properties for the keys to access control enforcer circuit 103 through bus 111. The agents 109-110 can also generate hardware identifiers for keys and hardware properties for the keys that are provided to access control enforcer circuit 103 through bus 111. The access control enforcer circuit 103 stores the hardware identifiers and the hardware properties for the keys in the access control attributes circuit 102.

The generation of the hardware identifiers by HW ID generator 117 or 118 can be static using hardware or can be programmable using trusted software or firmware. As an example, a hardware identifier can be generated using Read Only Memory (ROM) code or a high privilege software component of a circuit design. The hardware identifiers can be any identifiers that propagate over the connectivity interface in bus 111 with a transaction (e.g., a Security Attributes of Initiator (SAI) or a World Identifier (WID) as defined by RISC-V's World Guard security model). The connectivity interface can be AXI and can use AXI user bits to propagate the hardware identifiers. The connectivity interface can use any equivalent fields in other connectivity networks-on-chip (NOCs).

The access control enforcer circuit 103 can provide keys to the hardware sequencer circuit 104. The hardware sequencer circuit 104 can implement various key related functions, such as key derivation functions, key wrap functions, and key unwrap functions as examples. The hardware sequencer circuitry 104 can provide keys to external cryptographic engines 106 through bus 112.

When software or firmware running on one of the CPU core circuits 107-108 needs to access a key stored in key store system 101, the CPU core circuit sends a request through the bus 111 (e.g., through AXI fabric) requesting the key. The hardware (HW) ID generator 117 or 118 in the CPU core circuit 107 or 108, respectively, tags every request with a unique hardware identifier identifying the CPU core circuit and the software/firmware/hardware executing on the CPU core circuit that initiated the request.

Three techniques are disclosed herein for preventing unauthorized or compromised firmware, or any other agent, from accessing or using keys stored in key store system 101. The first technique is now discussed in detail. Initially, a requester (such as hardware, software, or firmware in one of CPU core circuits 107-108 or in one of agents 109-110) generates a request to access a key from key store system 101. The requestor causes the request to include a hardware identifier that identifies the requester as the owner of the key. In response to key store system 101 receiving a key access request that identifies the requester with a hardware identifier, access control enforcer circuit 103 access the hardware identifier for that key from access control attributes circuit 102. The access control enforcer circuit 103 then compares the hardware identifier in the request with the hardware identifier for that same key that was accessed from access control attributes circuit 102.

If the hardware identifier in the request matches the hardware identifier accessed from access control attributes circuit 102, access control enforcer circuit 103 accesses the key requested by the request from the key storage circuit 105. Then, access control enforcer circuit 103 returns the key accessed from key storage circuit 105 to the requester that requested the key through bus 111. If the hardware identifier in the request does not match the hardware identifier accessed from access control attributes circuit 102, or if the request does not include a hardware identifier, then access control enforcer circuit 103 denies the request for the key, and access control enforcer circuit 103 does not provide the key to the requester, according to the first technique.

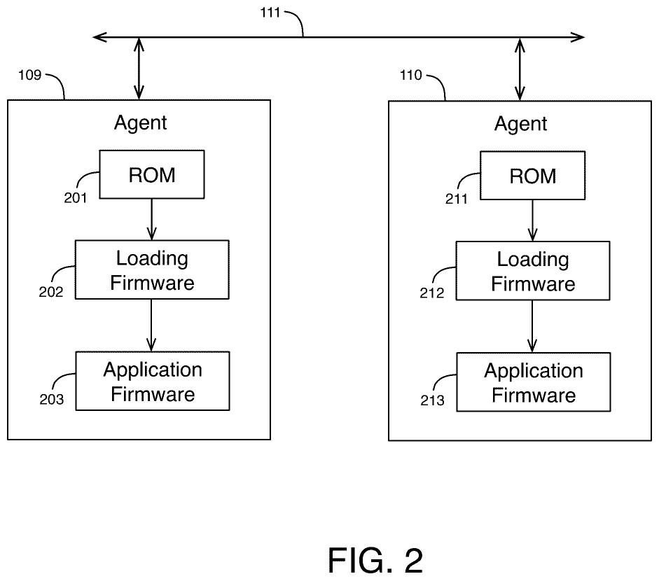

FIG. 2 is a diagram that illustrates detailed examples of agents 109 and 110 of FIG. 1 that can implement the first technique for key access control disclosed herein. Each of the agents 109 and 110 can be any type of computing system or a portion thereof, such as a central processing unit (CPU), a CPU core, or other processing circuit. Agent 109 includes a read only memory (ROM) 201, loading firmware 202, and application firmware 203. In response to agent 109 being initialized, ROM 201 begins operation and then passes control to loading firmware 202. Then, after the loading firmware 202 has completed a set of operations, the loading firmware 202 passes control to the application firmware 203. Agent 110 includes a read only memory (ROM) 211, loading firmware 212, and application firmware 213. In response to agent 110 being initialized, ROM 211 begins operation and then passes control to loading firmware 212. Then, after the loading firmware 212 has completed a set of operations, the loading firmware 212 passes control to the application firmware 213.

According to the example of FIG. 2, any of the ROM 201, ROM 211, loading firmware 202, loading firmware 212, application firmware 203, or application firmware 213 can request that key store system 101 create a key and store that key in the key storage circuit 105. The requester of the key (e.g., any of ROM 201, ROM 211, loading firmware 202 or 212, or application firmware 203 or 213) also generates a hardware identifier that identifies the requester ROM, firmware, or application firmware as the owner of the key. The requester of the key causes the hardware identifier to identify a hardware system and a subcomponent of the hardware system (e.g., hardware, firmware, or software in the hardware system) that is the owner of the key and that generated the request to create (or access) the key. The key store system 101 uses the hardware identifier to identify the requester as the owner of the key.

For example, ROM 201 causes a hardware identifier for a key requested by ROM 201 to identify ROM 201 and agent 109. As another example, loading firmware 202 causes a hardware identifier for a key requested by loading firmware 202 to identify loading firmware 202 and agent 109. As yet another example, application firmware 203 causes a hardware identifier for a key requested by application firmware 203 to identify application firmware 203 and agent 109. As yet another example, application firmware 213 causes a hardware identifier for a key requested by application firmware 213 to identify application firmware 213 and agent 110.

The requester transmits the hardware identifier along with the request to create the key to key store system 101. Key store system 101 then generates the key for the requester, stores the newly generated key in key storage circuit 105, and stores the hardware identifier that identifies the requester and the key owner in access control attributes circuit 102. The access control attributes circuit 102 can, for example, include a table (e.g., implemented by a lookup table) that associates each key stored in key storage circuit 105 with a hardware identifier that identifies the owner of that key.

In response to receiving a request that includes a hardware identifier from a requester (e.g., any of ROM 201, ROM 211, loading firmware 202 or 212, or application firmware 203 or 213) to access a key stored in key store system 101, access control enforcer circuit 103 accesses the hardware identifier for that key from access control attributes circuit 102 (e.g., by sending a request to access control attributes circuit 102). Then, access control enforcer circuit 103 compares the hardware identifier in the request with the hardware identifier for that key that was accessed from access control attributes circuit 102.

If the hardware identifier in the request matches the hardware identifier accessed from access control attributes circuit 102, such that the two hardware identifiers identify the same hardware system and the same subcomponent of the hardware system (e.g., the same hardware/software/firmware in the hardware system), access control enforcer circuit 103 accesses the key requested by the request from the key storage circuit 105. Then, access control enforcer circuit 103 transmits the key accessed from key storage circuit 105 to the requester that requested the key through bus 111. As examples, if a hardware identifier in a request and the hardware identifier accessed from access control attributes circuit 102 both identify ROM 211 in agent 110 (or both identify ROM 201 in agent 109), then access control enforcer circuit 103 accesses the key requested by the request from key storage circuit 105 and transmits the accessed key to the requester that requested the key through bus 111.

If the hardware identifier in the request does not match the hardware identifier accessed from access control attributes circuit 102, such that the two hardware identifiers identify different hardware systems or different subcomponents of the same hardware system, then access control enforcer circuit 103 denies the request for the key, and access control enforcer circuit 103 does not provide the key to the requester. As examples, if a hardware identifier in a request for a key identifies loading firmware 212 or application firmware 213 in agent 110, and the hardware identifier accessed from access control attributes circuit 102 for the same key identifies ROM 211 in agent 110, then access control enforcer circuit 103 denies the request for the key, and access control enforcer circuit 103 does not provide the key to the requester.

Thus, key store system 101 uses the hardware identifiers to distinguish between requesters of keys within a single hardware system (such as the ROM, loading firmware, and application firmware in a single computing system). The key store system 101 grants requests for keys if the hardware identifiers identify the same hardware system and the same hardware, software, or firmware within a single hardware system. Key store system 101 denies requests for keys if the hardware identifiers identify different hardware, software, or firmware in a single hardware system or different hardware systems.

The second technique for key access control disclosed herein is now discussed in detail. A requester (such as hardware, software, or firmware in one of CPU core circuits 107-108 or in one of agents 109-110) initiates a request to access a key from key store system 101. As discussed above, access control attributes circuit 102 stores hardware properties for the keys stored in key storage circuit 105 that indicate whether the keys are protected or unprotected. The hardware properties can also identify the hardware, software, and/or firmware that requested key store system 101 to generate each key.

In response to receiving a request to access a key from key store system 101, the access control enforcer circuit 103 accesses the hardware property for that key from the access control attributes circuit 102. If the hardware property accessed from access control attributes circuit 102 indicates that the key is a protected key, then the access control enforcer circuit 103 does not return the key to the requester, and the access control enforcer circuit 103 only allows the requester of the key to request that the key be used to derive another key, according to the second technique. As another example, if the hardware property for a key accessed from access control attributes circuit 102 identifies hardware, software, or firmware that does not match the hardware identifier sent by the requester, then access control enforcer circuit 103 does not return the key to the requester.

The hardware sequencer circuit 104 implements the key derivation functions. A requester (e.g., software, firmware, or hardware in agents 109-110, etc.) can initiate different types of key derivation requests. A first type of key derivation request is a request to derive a key that has a low security level (i.e., a low security key). A second type of key derivation request is a request to derive a high security key.

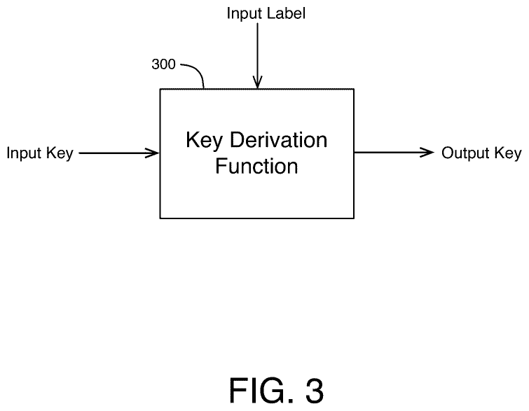

FIG. 3 is a diagram that illustrates an example of an implementation of a key derivation function 300 in the hardware sequencer circuit 104 of Figure (FIG. 1. FIG. 3 illustrates a standard key derivation function 300 that is compliant to standards of the National Institute of Standards and Technology (NIST). The key derivation function 300 is implemented in the hardware sequencer circuit 104. The key derivation function 300 implements a cryptographic algorithm that uses an input label as part of the key derivation that cryptographically impacts the key derivation. The key derivation function 300 receives an input key from access control enforcer circuit 103 and an input label. The key derivation function 300 derives an output key based on the input key and generates a security label for the output key that is based on the input label. The output key generated by the key derivation function 300 can be provided to the access control enforcer circuit 103.

The input label provided to the key derivation function 300 can, as examples, indicate whether the key to be derived by the key derivation function 300 should have a high security label, a low security label, or a label that identifies the owner of the key. In response to the key derivation function 300 receiving an input label indicating high security, the key derivation function 300 generates an output key having a high security label. In response to the key derivation function 300 receiving an input label indicating low security, the key derivation function 300 generates an output key having a low security label. The key store system 101 ensures that the keys having high security labels are never exposed to firmware or software outside key store system 101 and are only routable to other hardware components, thereby protecting the keys having high security labels from unauthorized or compromised firmware or software. The keys having low security labels can be returned back to firmware or software for other uses.

In response to the key derivation function 300 receiving an input label identifying an owner of the input key (e.g., any of CPU core 107 or 108, ROM 201 or 211, loading firmware 202 or 212, or application firmware 203 or 213), the key derivation function 300 generates an output key having a label identifying the same owner, and the key store system 101 ensures that the output key is only returned to the owner identified by the label. Thus, key derivation function 300 ensures that an output key derived from an input key inherits the security property and key ownership of the input key.

The security labels for keys derived using key derivation function 300 prevent any unauthorized firmware or software from re-creating or re-building a high security key using key store system 101. If an unauthorized requester does not have access to an original hardware protected key, any attempt to trick the key store system 101 to derive a key having a high security label may cause the key store system 101 to create the key, but the key store system 101 prevents the unauthorized requester from receiving the key having the high security label. The key having the high security label is protected within hardware in key store system 101 from access by the unauthorized requester.

As an example, the key derivation function 300 can derive keys (e.g., link encryption keys or memory encryption keys) that are used by the external cryptographic engines 106 to encrypt and decrypt bitstreams and data. For example, the external cryptographic engines 106 can include bitstream encryption and/or decryption cryptographic accelerators that use one or more keys derived by the key derivation function 300 to encrypt and/or decrypt bitstreams of configuration data that are used to configure one or more configurable integrated circuits, such as FPGAs and/or PLDs. The key store system 101 can directly program the external cryptographic engines 106 to the hardware, thereby increasing defense in depth for those keys.

The third technique for key access control disclosed herein is now discussed in detail. According to the third technique, the key store system 101 generates (or receives from an external source) a hardware attribute that is associated with a key and that is stored in the access control attributes circuit 102. If a key stored in key storage circuit 105 has this hardware attribute associated with the key, then key store system 101 only allows the key to be used as a wrapping and unwrapping key by the hardware sequencer circuit 104.

Thus, according to the third technique, when a key is associated with the hardware attribute that only permits the key to be used for wrapping or unwrapping, the key store system 101 only permits software or firmware that is external to key store system 101 to request the key to be used to wrap or unwrap other keys. When a key is associated with the hardware attribute that only permits the key to be used for wrapping or unwrapping, hardware sequencer circuit 104 never exposes the key outside of key store system 101 or external cryptographic engines 106, but the hardware sequencer circuit 104 allows the key to be used for wrapping or unwrapping other user provided keys.

When the hardware sequencer circuit 104 unwraps keys associated with the hardware attribute according to the third technique, the unwrapped keys can only be stored into key storage circuit 105 for other protected functions (e.g., additional key derivations) or transmitted to external hardware cryptographic engines 106 to perform cryptographic functions. According to an exemplary application for a key having the hardware attribute, the hardware sequencer circuit 104 can unwrap a bitstream decryption key used for a customer circuit design for a configurable IC and then transmit the unwrapped bitstream decryption key directly to bitstream decryption hardware in external cryptographic engines 106. This application tremendously increases the robustness of the bitstream decryption flow, because the key associated with the hardware attribute is never available to firmware even if the key is hacked. Wrapped keys can be returned to software or firmware that is external to key store system 101, but the third technique is mainly used to protect unwrapped keys and prevent exposure of the unwrapped keys.

The three techniques disclosed above can, for example, be combined together to build a robust secure key management system that removes firmware external to key store system 101 from the trust network for high security keys. As an example of an application that uses one or more of the three techniques disclosed above, the key store system 101 can use device specific secret keys to derive wrapping and unwrapping keys. An unwrapping key can be used to unwrap a key stored in a storage device (e.g., a fuse), and the unwrapped key can be directly routed to the external cryptographic engines 106 for use in performing cryptographic functions.

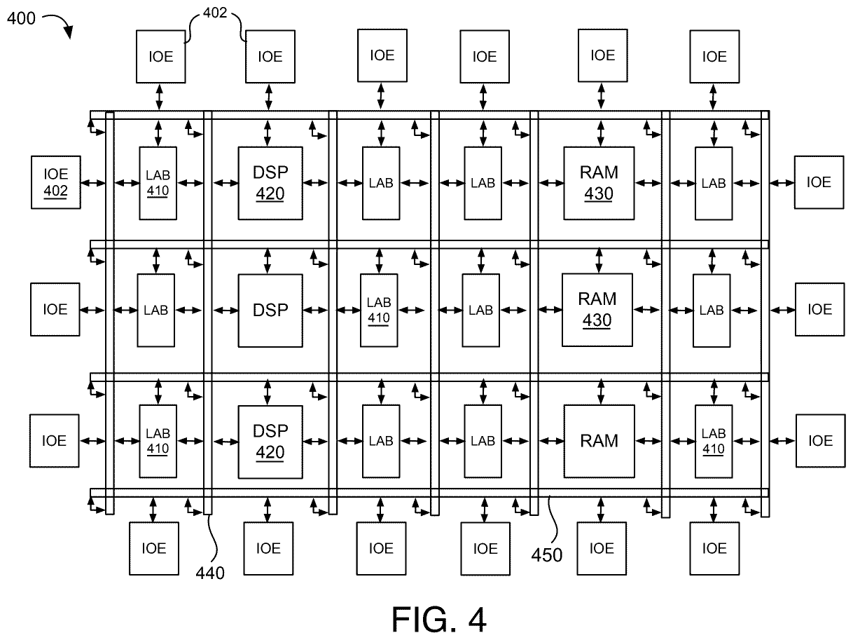

FIG. 4 is a diagram of an illustrative example of a configurable integrated circuit (IC) 400. Configurable IC 400 is an example of an IC that can include the systems and circuits disclosed herein with respect to FIGS. 1-3. As shown in FIG. 4, the configurable integrated circuit 400 includes a two-dimensional array of configurable logic circuit blocks, including logic array blocks (LABs) 410 and other configurable logic circuit blocks, such as random access memory (RAM) blocks 430 and digital signal processing (DSP) blocks 420, for example. Configurable logic circuit blocks, such as LABs 410, can include smaller configurable regions (e.g., configurable logic elements, configurable logic blocks, or adaptive logic modules (ALMs)) that receive input signals and perform custom functions on the input signals to produce output signals.

The configurable integrated circuit 400 also includes programmable interconnect circuitry in the form of vertical routing channels 440 (i.e., interconnects formed along a vertical axis of configurable integrated circuit 400) and horizontal routing channels 450 (i.e., interconnects formed along a horizontal axis of configurable integrated circuit 400), each routing channel including at least one track to route at least one wire. One or more of the routing channels 440 and/or 450 can be part of a network-on-chip (NOC) having router circuits.

In addition, the configurable integrated circuit 400 has input/output elements (IOEs) 402 (e.g., including IO circuit blocks) for driving signals off of configurable integrated circuit 400 and for receiving signals from other devices. Input/output elements 402 can include parallel input/output circuitry, serial data transceiver circuitry, differential receiver and transmitter circuitry, or other circuitry used to connect one integrated circuit to another integrated circuit. Input/output elements 402 can include general purpose input/output (GPIO) circuitry (e.g., on the top and bottoms edges of IC 400), high-speed input/output (HSIO) circuitry (e.g., on the left edge of IC 400), and on-package input/output (OPIOs) circuitry (e.g., on the right edge of IC 400).

As shown, input/output elements 402 can be located around the periphery of the IC. If desired, the configurable integrated circuit 400 can have input/output elements 402 arranged in different ways. For example, input/output elements 402 can form one or more columns of input/output elements that can be located anywhere on the configurable integrated circuit 400 (e.g., distributed evenly across the width of the configurable integrated circuit). If desired, input/output elements 402 can form one or more rows of input/output elements (e.g., distributed across the height of the configurable integrated circuit). Alternatively, input/output elements 402 can form islands of input/output elements that can be distributed over the surface of the configurable integrated circuit 400 or clustered in selected areas.

Note that other routing topologies, besides the topology of the interconnect circuitry depicted in FIG. 4, can be used. For example, the routing topology can include wires that travel diagonally or that travel horizontally and vertically along different parts of their extent as well as wires that are perpendicular to the device plane in the case of three dimensional integrated circuits, and the driver of a wire can be located at a different point than one end of a wire. The routing topology can include global wires that span substantially all of configurable integrated circuit 400, fractional global wires such as wires that span part of configurable integrated circuit 400, staggered wires of a particular length, smaller local wires, or any other suitable interconnection resource arrangement.

Furthermore, it should be understood that examples disclosed herein may be implemented in any type of integrated circuit. If desired, the functional blocks of such an integrated circuit can be arranged in more levels or layers in which multiple functional blocks are interconnected to form still larger blocks. Other device arrangements can use functional blocks that are not arranged in rows and columns.

Configurable integrated circuit 400 can also contain programmable memory elements. The memory elements can be loaded with configuration data (also called programming data) using input/output elements (IOEs) 402. Once loaded, the memory elements each provide a corresponding static control signal that controls the operation of an associated functional block (e.g., LABs 410, DSP 420, RAM 430, or input/output elements 402).

In a typical scenario, the outputs of the loaded memory elements are applied to the gates of field-effect transistors in a functional block to turn certain transistors on or off and thereby configure the logic in the functional block including the routing paths. Programmable logic circuit elements that are controlled in this way include parts of multiplexers (e.g., multiplexers used for forming routing paths in interconnect circuits), look-up tables, logic arrays, AND, OR, NAND, and NOR logic gates, pass gates, etc.

The memory elements can use any suitable volatile and/or non-volatile memory structures such as random-access-memory (RAM) cells, fuses, antifuses, programmable read-only-memory memory cells, mask-programmed and laser-programmed structures, combinations of these structures, etc. Because the memory elements are loaded with configuration data during programming, the memory elements are sometimes referred to as configuration memory or programmable memory elements.

The programmable memory elements can be organized in a configuration memory array consisting of rows and columns. A data register that spans across all columns and an address register that spans across all rows can receive configuration data. The configuration data can be shifted onto the data register. When the appropriate address register is asserted, the data register writes the configuration data to the configuration memory elements of the row that was designated by the address register.

Configurable integrated circuit 400 can include configuration memory that is organized in sectors, whereby a sector can include the configuration bits that specify the function and/or interconnections of the subcomponents and wires in or crossing that sector. Each sector can include separate data and address registers.

The configurable IC 400 of FIG. 4 is merely one example of an IC that can be used with embodiments disclosed herein. The embodiments disclosed herein can be used with any suitable electronic integrated circuit or system. For example, the embodiments disclosed herein can be used with numerous types of electronic devices such as processor integrated circuits, central processing units, memory integrated circuits, graphics processing unit integrated circuits, application specific standard products (ASSPs), application specific integrated circuits (ASICs), and configurable logic integrated circuits. Examples of configurable logic integrated circuits include programmable arrays logic (PALs), programmable logic arrays (PLAs), field programmable logic arrays (FPLAs), electrically programmable logic devices (EPLDs), electrically erasable programmable logic devices (EEPLDs), logic cell arrays (LCAs), complex programmable logic devices (CPLDs), and field programmable gate arrays (FPGAs), just to name a few.

The integrated circuits disclosed in one or more embodiments herein can be part of a data processing system that includes one or more of the following components: a processor; memory; input/output circuitry; and peripheral devices. The data processing system can be used in a wide variety of applications, such as computer networking, data networking, instrumentation, video processing, digital signal processing, or any suitable other application. The integrated circuits can be used to perform a variety of different logic functions.

In general, software and data for performing any of the functions disclosed herein can be stored in non-transitory computer readable storage media. Non-transitory computer readable storage media is tangible computer readable storage media that stores data and software for access at a later time, as opposed to media that only transmits propagating electrical signals (e.g., wires). The software code may sometimes be referred to as software, data, program instructions, instructions, or code. The non-transitory computer readable storage media can, for example, include computer memory chips, non-volatile memory such as non-volatile random-access memory (NVRAM), one or more hard drives (e.g., magnetic drives or solid state drives), one or more removable flash drives or other removable media, compact discs (CDs), digital versatile discs (DVDs), Blu-ray discs (BDs), other optical media, and floppy diskettes, tapes, or any other suitable memory or storage device(s).

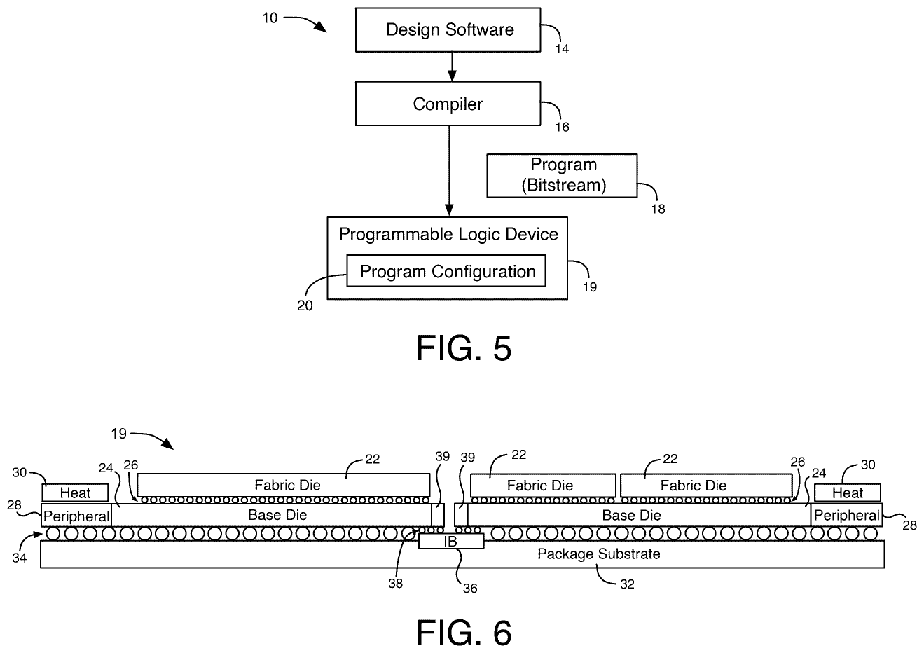

FIG. 5 illustrates a block diagram of a system 10 that can be used to implement a circuit design to be programmed onto a programmable logic device 19 using design software. A designer can implement circuit design functionality on an integrated circuit, such as a reconfigurable programmable logic device 19 (e.g., a field programmable gate array (FPGA)). The designer can implement the circuit design to be programmed onto the programmable logic device 19 using design software 14. The design software 14 can use a compiler 16 to generate a low-level circuit-design program (bitstream) 18, sometimes known as a program object file and/or configuration program, that programs the programmable logic device 19. Thus, the compiler 16 can provide machine-readable instructions representative of the circuit design to the programmable logic device 19. For example, the programmable logic device 19 can receive one or more programs (bitstreams) 18 that describe the hardware implementations that should be stored in the programmable logic device 19. A program (bitstream) 18 can be programmed into the programmable logic device 19 as a configuration program 20. The configuration program 20 can, in some cases, represent an accelerator function to perform for machine learning, video processing, voice recognition, image recognition, or other highly specialized task.

In some implementations, a programmable logic device can be any integrated circuit device that includes a programmable logic device with two separate integrated circuit die where at least some of the programmable logic fabric is separated from at least some of the fabric support circuitry that operates the programmable logic fabric. One example of such a programmable logic device is shown in FIG. 6, but many others can be used, and it should be understood that this disclosure is intended to encompass any suitable programmable logic device where programmable logic fabric and fabric support circuitry are at least partially separated on different integrated circuit die.

FIG. 6 is a diagram that depicts an example of the programmable logic device 19 that includes three fabric die 22 and two base die 24 that are connected to one another via microbumps 26. In the example of FIG. 6, at least some of the programmable logic fabric of the programmable logic device 19 is in the three fabric die 22, and at least some of the fabric support circuitry that operates the programmable logic fabric is in the two base die 24. For example, some of the circuitry of configurable IC 400 shown in FIG. 4 (e.g., LABs 410, DSP 420, and RAM 430) can be located in the fabric die 22 and some of the circuitry of IC 400 (e.g., input/output elements 402) can be located in the base die 24.

Although the fabric die 22 and base die 24 appear in a one-to-one relationship or a two-to-one relationship in FIG. 6, other relationships can be used. For example, a single base die 24 can attach to several fabric die 22, or several base die 24 can attach to a single fabric die 22, or several base die 24 can attach to several fabric die 22 (e.g., in an interleaved pattern). Peripheral circuitry 28 can be attached to, embedded within, and/or disposed on top of the base die 24, and heat spreaders 30 can be used to reduce an accumulation of heat on the programmable logic device 19. The heat spreaders 30 can appear above, as pictured, and/or below the package (e.g., as a double-sided heat sink). The base die 24 can attach to a package substrate 32 via conductive bumps 34. In the example of FIG. 6, two pairs of fabric die 22 and base die 24 are shown communicatively connected to one another via an interconnect bridge 36 (e.g., an embedded multi-die interconnect bridge (EMIB)) and microbumps 38 at bridge interfaces 39 in base die 24.

In combination, the fabric die 22 and the base die 24 can operate in combination as a programmable logic device 19 such as a field programmable gate array (FPGA). It should be understood that an FPGA can, for example, represent the type of circuitry, and/or a logical arrangement, of a programmable logic device when both the fabric die 22 and the base die 24 operate in combination. Moreover, an FPGA is discussed herein for the purposes of this example, though it should be understood that any suitable type of programmable logic device can be used.

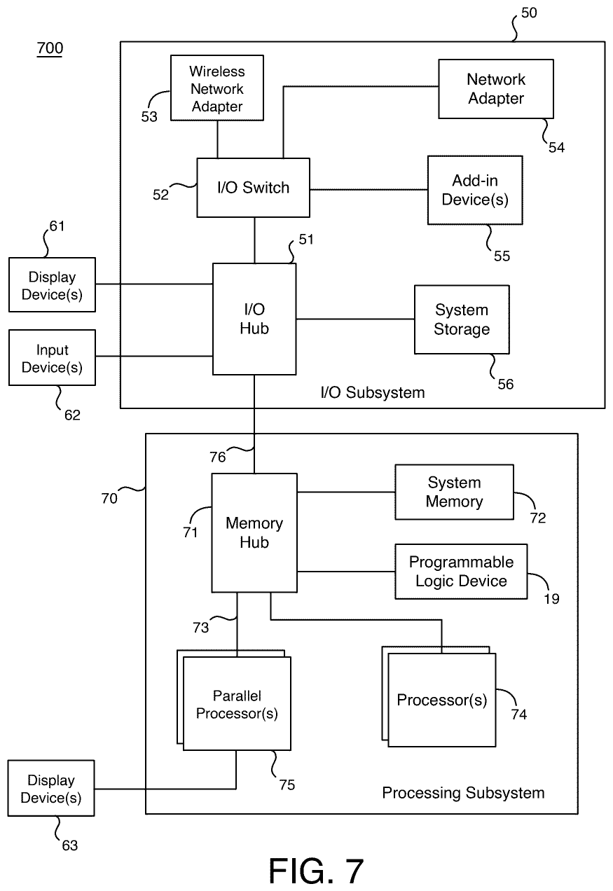

FIG. 7 is a block diagram illustrating a computing system 700 configured to implement one or more aspects of the embodiments described herein. The computing system 700 includes a processing subsystem 70 having one or more processor(s) 74, a system memory 72, and a programmable logic device 19 communicating via an interconnection path that can include a memory hub 71. The memory hub 71 can be a separate component within a chipset component or can be integrated within the one or more processor(s) 74. The memory hub 71 couples with an input/output (I/O) subsystem 50 via a communication link 76. The I/O subsystem 50 includes an input/output (I/O) hub 51 that can enable the computing system 700 to receive input from one or more input device(s) 62. Additionally, the I/O hub 51 can enable a display controller, which can be included in the one or more processor(s) 74, to provide outputs to one or more display device(s) 61. In one embodiment, the one or more display device(s) 61 coupled with the I/O hub 51 can include a local, internal, or embedded display device.

In one embodiment, the processing subsystem 70 includes one or more parallel processor(s) 75 coupled to memory hub 71 via a bus or other communication link 73. The communication link 73 can use one of any number of standards based communication link technologies or protocols, such as, but not limited to, PCI Express, or can be a vendor specific communications interface or communications fabric. In one embodiment, the one or more parallel processor(s) 75 form a computationally focused parallel or vector processing system that can include a large number of processing cores and/or processing clusters, such as a many integrated core (MIC) processor. In one embodiment, the one or more parallel processor(s) 75 form a graphics processing subsystem that can output pixels to one of the one or more display device(s) 61 coupled via the I/O Hub 51. The one or more parallel processor(s) 75 can also include a display controller and display interface (not shown) to enable a direct connection to one or more display device(s) 63.

Within the I/O subsystem 50, a system storage unit 56 can connect to the I/O hub 51 to provide a storage mechanism for the computing system 700. An I/O switch 52 can be used to provide an interface mechanism to enable connections between the I/O hub 51 and other components, such as a network adapter 54 and/or a wireless network adapter 53 that can be integrated into the platform, and various other devices that can be added via one or more add-in device(s) 55. The network adapter 54 can be an Ethernet adapter or another wired network adapter. The wireless network adapter 53 can include one or more of a Wi-Fi, Bluetooth, near field communication (NFC), or other network device that includes one or more wireless radios.

The computing system 700 can include other components not shown in FIG. 7, including other port connections, optical storage drives, video capture devices, and the like, that can also be connected to the I/O hub 51. Communication paths interconnecting the various components in FIG. 7 can be implemented using any suitable protocols, such as PCI (Peripheral Component Interconnect) based protocols (e.g., PCI-Express), or any other bus or point-to-point communication interfaces and/or protocol(s), such as the NV-Link high-speed interconnect, or interconnect protocols known in the art.

In one embodiment, the one or more parallel processor(s) 75 incorporate circuitry optimized for graphics and video processing, including, for example, video output circuitry, and constitutes a graphics processing unit (GPU). In another embodiment, the one or more parallel processor(s) 75 incorporate circuitry optimized for general purpose processing, while preserving the underlying computational architecture. In yet another embodiment, components of the computing system 700 can be integrated with one or more other system elements on a single integrated circuit. For example, the one or more parallel processor(s) 75, memory hub 71, processor(s) 74, and I/O hub 51 can be integrated into a system on chip (SoC) integrated circuit. Alternatively, the components of the computing system 700 can be integrated into a single package to form a system in package (SIP) configuration. In one embodiment, at least a portion of the components of the computing system 700 can be integrated into a multi-chip module (MCM), which can be interconnected with other multi-chip modules into a modular computing system.

The computing system 700 shown herein is illustrative. Other variations and modifications are also possible. The connection topology, including the number and arrangement of bridges, the number of processor(s) 74, and the number of parallel processor(s) 75, can be modified as desired. For instance, in some embodiments, system memory 72 is connected to the processor(s) 74 directly rather than through a bridge, while other devices communicate with system memory 72 via the memory hub 71 and the processor(s) 74. In other alternative topologies, the parallel processor(s) 75 are connected to the I/O hub 51 or directly to one of the one or more processor(s) 74, rather than to the memory hub 71. In other embodiments, the I/O hub 51 and memory hub 71 can be integrated into a single chip. Some embodiments can include two or more sets of processor(s) 74 attached via multiple sockets, which can couple with two or more instances of the parallel processor(s) 75.

Some of the particular components shown herein are optional and may not be included in all implementations of the computing system 700. For example, any number of add-in cards or peripherals can be supported, or some components can be eliminated. Furthermore, some architectures can use different terminology for components similar to those illustrated in FIG. 7. For example, the memory hub 71 can be referred to as a Northbridge in some architectures, while the I/O hub 51 can be referred to as a Southbridge.

Additional examples are now described. Example 1 is an integrated circuit comprising: a key storage circuit for storing a first key; and an access control enforcer circuit for granting access to the first key stored in the key storage circuit in response to receiving a first request based on a first hardware identifier that identifies a hardware system and a subcomponent of the hardware system that is an owner of the first key.

In Example 2, the integrated circuit of Example 1 further comprises: an access control attributes circuit for storing a second hardware identifier for the first key, wherein the access control enforcer circuit grants access to the first key if the first hardware identifier matches the second hardware identifier accessed from the access control attributes circuit.

In Example 3, the integrated circuit of any one of Examples 1-2 can optionally include, wherein the subcomponent of the hardware system is at least one of hardware, firmware, or software in the hardware system.

In Example 4, the integrated circuit of any one of Examples 1-3 further comprises: a hardware sequencer circuit that ensures that a second key derived from the first key inherits a security property and a key ownership of the first key.

In Example 5, the integrated circuit of any one of Examples 1-4 further comprises: a hardware sequencer circuit that only performs a key derivation on the first key defined as high security with the first hardware identifier as a label for the key derivation, wherein the first hardware identifier is different from an attribute used for a second key defined as low security.

In Example 6, the integrated circuit of any one of Examples 1-5 further comprises: a hardware sequencer circuit that only allows key derivations on second keys defined as low security with attributes that are hardware defined.

In Example 7, the integrated circuit of any one of Examples 1-6 can optionally include, wherein the access control enforcer circuit ensures that a second key defined as low security is allowed to be accessed by the subcomponent of the hardware system from the key storage circuit if ownership of the second key matches a second hardware identifier in a second request.

In Example 8, the integrated circuit of any one of Examples 1-7 can optionally include, wherein the access control enforcer circuit ensures that the first key is prevented from being transmitted to the subcomponent of the hardware system if the first key is associated with a high security label.

In Example 9, the integrated circuit of any one of Examples 1-8 further comprises: a hardware sequencer circuit that allows the first key to be used to perform key wrap and key unwrap functions if the first key is defined as high security.

Example 10 is a method for controlling access to a key, the method comprising: accessing a first hardware identifier for the key from an access control attributes circuit in response to receiving a request to access the key that comprises a second hardware identifier, wherein the first hardware identifier identifies a hardware system and a subcomponent of the hardware system that is an owner of the key; comparing the first hardware identifier with the second hardware identifier using an access control enforcer circuit; and accessing the key from a key storage circuit using the access control enforcer circuit if the subcomponent of the hardware system identified by the first hardware identifier matches the subcomponent of the hardware system identified by the second hardware identifier.

In Example 11, the method of Example 10 further comprises: transmitting the key accessed from the key storage circuit to a requester that generated the request using the access control enforcer circuit only if the subcomponent of the hardware system identified by the first hardware identifier matches the subcomponent of the hardware system identified by the second hardware identifier.

In Example 12, the method of any one of Examples 10-11 further comprises: denying the request to access the key using the access control enforcer circuit if the subcomponent of the hardware system identified by the first hardware identifier does not match the subcomponent of the hardware system identified by the second hardware identifier.

In Example 13, the method of any one of Examples 10-12 further comprises: performing a key derivation function on the key using a hardware sequencer circuit if the key is associated with a high security label stored in the access control attributes circuit; and preventing the key from being transmitting to a requester that generated the request using the access control enforcer circuit if the key is associated with the high security label.

In Example 14, the method of any one of Examples 10-13 further comprises: determining if the key is associated with a low security label stored in the access control attributes circuit; and transmitting the key accessed from the key storage circuit to a requester that generated the request using the access control enforcer circuit only if the key is associated with the low security label.

In Example 15, the method of any one of Examples 10-14 further comprises: allowing the key to be used to perform key wrap and key unwrap functions if the key is associated with a hardware attribute using a hardware sequencer circuit.

Example 16 is a computing system comprising: a key storage circuit for storing a first key; an access control attributes circuit for storing a hardware property for the first key; and an access control enforcer circuit for accessing the hardware property for the first key from the access control attributes circuit in response to a request to access the first key, wherein the access control enforcer circuit prevents the first key from being returned to an initiator of the request if the hardware property indicates that the first key is protected, and wherein the access control enforcer circuit permits the first key to be used to derive a second key if the hardware property indicates that the first key is protected.

In Example 17, the computing system of Example 16 further comprises: a hardware sequencer circuit comprising a key derivation function that derives the second key from the first key, wherein the key derivation function ensures that the second key inherits a security property or a key ownership of the first key.

In Example 18, the computing system of any one of Examples 16-17 can optionally include, wherein the access control enforcer circuit only allows the first key to be used as a wrapping and unwrapping key if a hardware attribute associated with the first key is stored in the access control attributes circuit.

In Example 19, the computing system of any one of Examples 16-18 can optionally include, wherein the access control enforcer circuit only grants access to the first key to the initiator if a first hardware identifier for the first key stored in the access control attributes circuit matches a second hardware identifier that is associated with the request, and wherein the first hardware identifier identifies a hardware system and a subcomponent of the hardware system that is an owner of the first key.

In Example 20, the computing system of any one of Examples 16-19 further comprising: a cryptographic engine; and a hardware sequencer circuit that unwraps a third key using the first key and that provides the third key to the cryptographic engine if the first key is associated with a hardware attribute that limits the first key as a wrapping and unwrapping key, and wherein the cryptographic engine performs a cryptographic function using the third key.

The foregoing description of the exemplary embodiments has been presented for the purpose of illustration. The foregoing description is not intended to be exhaustive or to be limiting to the examples disclosed herein. The foregoing is merely illustrative of the principles of this disclosure and various modifications can be made by those skilled in the art. The foregoing embodiments may be implemented individually or in any combination.

What is claimed is:

1. An integrated circuit comprising:
a key storage circuit for storing a first key; and
an access control enforcer circuit for granting access to the first key stored in the key storage circuit in response to receiving a first request based on a first hardware identifier that identifies a hardware system and a subcomponent of the hardware system that is an owner of the first key.

2. The integrated circuit of claim 1 further comprising:
an access control attributes circuit for storing a second hardware identifier for the first key, wherein the access control enforcer circuit grants access to the first key if the first hardware identifier matches the second hardware identifier accessed from the access control attributes circuit.

3. The integrated circuit of claim 1, wherein the subcomponent of the hardware system is at least one of hardware, firmware, or software in the hardware system.

4. The integrated circuit of claim 1 further comprising:
a hardware sequencer circuit that ensures that a second key derived from the first key inherits a security property and a key ownership of the first key.

5. The integrated circuit of claim 1 further comprising:
a hardware sequencer circuit that only performs a key derivation on the first key defined as high security with the first hardware identifier as a label for the key derivation, wherein the first hardware identifier is different from an attribute used for a second key defined as low security.

6. The integrated circuit of claim 1 further comprising:
a hardware sequencer circuit that only allows key derivations on second keys defined as low security with attributes that are hardware defined.

7. The integrated circuit of claim 1, wherein the access control enforcer circuit ensures that a second key defined as low security is allowed to be accessed by the subcomponent of the hardware system from the key storage circuit if ownership of the second key matches a second hardware identifier in a second request.

8. The integrated circuit of claim 1, wherein the access control enforcer circuit ensures that the first key is prevented from being transmitted to the subcomponent of the hardware system if the first key is associated with a high security label.

9. The integrated circuit of claim 1 further comprising:
a hardware sequencer circuit that allows the first key to be used to perform key wrap and key unwrap functions if the first key is defined as high security.

10. A method for controlling access to a key, the method comprising:
accessing a first hardware identifier for the key from an access control attributes circuit in response to receiving a request to access the key that comprises a second hardware identifier, wherein the first hardware identifier identifies a hardware system and a subcomponent of the hardware system that is an owner of the key;
comparing the first hardware identifier with the second hardware identifier using an access control enforcer circuit; and
accessing the key from a key storage circuit using the access control enforcer circuit if the subcomponent of the hardware system identified by the first hardware identifier matches the subcomponent of the hardware system identified by the second hardware identifier.

11. The method of claim 10 further comprising:
transmitting the key accessed from the key storage circuit to a requester that generated the request using the access control enforcer circuit only if the subcomponent of the hardware system identified by the first hardware identifier matches the subcomponent of the hardware system identified by the second hardware identifier.

12. The method of claim 10 further comprising:
denying the request to access the key using the access control enforcer circuit if the subcomponent of the hardware system identified by the first hardware identifier does not match the subcomponent of the hardware system identified by the second hardware identifier.

13. The method of claim 10 further comprising:
performing a key derivation function on the key using a hardware sequencer circuit if the key is associated with a high security label stored in the access control attributes circuit; and
preventing the key from being transmitting to a requester that generated the request using the access control enforcer circuit if the key is associated with the high security label.

14. The method of claim 10 further comprising:
determining if the key is associated with a low security label stored in the access control attributes circuit; and
transmitting the key accessed from the key storage circuit to a requester that generated the request using the access control enforcer circuit only if the key is associated with the low security label.

15. The method of claim 10 further comprising:
allowing the key to be used to perform key wrap and key unwrap functions if the key is associated with a hardware attribute using a hardware sequencer circuit.

16. A computing system comprising:
a key storage circuit for storing a first key;
an access control attributes circuit for storing a hardware property for the first key; and
an access control enforcer circuit for accessing the hardware property for the first key from the access control attributes circuit in response to a request to access the first key, wherein the access control enforcer circuit prevents the first key from being returned to an initiator of the request if the hardware property indicates that the first key is protected, and wherein the access control enforcer circuit permits the first key to be used to derive a second key if the hardware property indicates that the first key is protected.

17. The computing system of claim 16 further comprising:
a hardware sequencer circuit comprising a key derivation function that derives the second key from the first key, wherein the key derivation function ensures that the second key inherits a security property or a key ownership of the first key.

18. The computing system of claim 16, wherein the access control enforcer circuit only allows the first key to be used as a wrapping and unwrapping key if a hardware attribute associated with the first key is stored in the access control attributes circuit.

19. The computing system of claim 16, wherein the access control enforcer circuit only grants access to the first key to the initiator if a first hardware identifier for the first key stored in the access control attributes circuit matches a second hardware identifier that is associated with the request, and wherein the first hardware identifier identifies a hardware system and a subcomponent of the hardware system that is an owner of the first key.

20. The computing system of claim 16 further comprising:
a cryptographic engine; and
a hardware sequencer circuit that unwraps a third key using the first key and that provides the third key to the cryptographic engine if the first key is associated with a hardware attribute that limits the first key as a wrapping and unwrapping key, and wherein the cryptographic engine performs a cryptographic function using the third key.
